(19) United States
(12) Patent Application Publication
(10) Pub. No.: US 2014/0244362 A1
(43) Pub. Date: Aug. 28, 2014

(54) SYSTEM AND METHOD TO PROVIDE PREDICTIVE ANALYSIS TOWARDS PERFORMANCE OF TARGET OBJECTS ASSOCIATED WITH ORGANIZATION

(71) Applicant: Tata Consultancy Services Limited, Mumbai (IN)

(72) Inventor: Dhruba Jyoti Chaudhury, Kolkata (IN)

(73) Assignee: Tata Consultancy Services Limited, Mumbai (IN)

(21) Appl. No.: 14/019,356

(22) Filed: Sep. 5, 2013

(30) Foreign Application Priority Data
Feb. 27, 2013 (IN) 578/MUM/2013

(51) Int. Cl. G06Q 10/06

(52) U.S. Cl. CPC G06Q 10/06375
USPC 705/7.37

(57) ABSTRACT

This disclosure relates to predictive performance analysis of target objects associated with an organization. In one embodiment, a performance predictive analysis method is disclosed, comprising: receiving one or more parameters and an associated intensity level to predict performance of a target object associated with an organization; determining a proportionality relation between the performance of the target object and the one or more parameters, by applying a logical regression technique over the one or more parameters; selecting a threshold value from a pre-defined truth table to convert the one or more parameters into one or more group-level model factors with the associated intensity level; determining an impact of the one or more parameters on the performance in terms of a band wise distribution; and identifying a probabilistic effect, based on the determined impact, of the proportionality relation between the performance of the target object and the one or more parameters.

### PRIORITY CLAIM

This U.S. patent application claims priority under 35 U.S.C. §119 to: India Application No. 578/MUM/2013, filed Feb. 27, 2013. The aforementioned application is incorporated herein by reference in its entirety.

### TECHNICAL FIELD

The present disclosure relates in general to performance analysis, and more particularly to a system and method to provide predictive performance analysis of one or more target objects associated with an organization.

### BACKGROUND

In recent years, organizations are increasingly focused on monitoring processes, their performance, and their evaluation. Organizations attempt to manage their performance by tracking and measuring it across dimensions. Organization performance may be measured in terms of effectiveness in achieving their goals by meeting targets that are aligned with some objectives associated with the target. Particularly, performance may be measured in terms of ability to effectively deploy services to a client to achieve a particular client satisfaction level. Meeting target performance signifies operational excellence, and improves customer loyalty.

An organization may have many units, each with numerous projects being executed simultaneously. Targets are set for the organization overall, which are then cascaded down first to the unit level, and then to the project level. Performance data may be analyzed at each project, unit and organizational level to formulate an action plan for future improvement. Currently, the performance analysis process is reactive, repetitive, and based on lag measurement.

### SUMMARY

Embodiments of the present disclosure describe a computer implemented system to provide predictive analysis towards performance of one or more target object associated with an organization with respect to one or more parameters affecting the performance. The system comprises a user interface configured to receive input parameters along with an intensity level, and a processor coupled to a memory. The processor is configured to determine a proportionality relation by using a logical regression technique, between the performance of the target object and the input parameter so selected. The processor further comprises a conversion module configured to select a threshold value from a pre-defined truth table to convert the input parameters selected by the user into group level model factors with the associated intensity level and an evaluation module configured to determine an impact of the parameters and further split the impact in order to obtain a band wise distribution. The band wise distribution comprises one or more numerical ranges depicting a probabilistic effect of parameters towards the performance of one or more target object. An output generation module is configured to generate a probabilistic effect of the impact over the proportionality relation so determined to further provide predictive analysis. The output generation module is further configured to generate a standard form of the band wise distribution so obtained and to provide one or more recommending action with respect to the probabilistic effect so depicted.

Embodiments of the present disclosure also provide a method performed on a computer to provide predictive analysis towards performance of one or more target object associated with an organization with respect to one or more parameters affecting the performance. The method comprises steps of allowing a user to select input parameters along with an intensity level. The input parameters and the intensity level so selected by the user are processed to determine a proportionality relation by using a logical regression technique, between the performance of the target object and the input parameter so selected. The processing comprises of steps of selecting a threshold value from a pre-defined truth table to convert the input parameters selected by the user into a group level model factors with the associated intensity level and determining an impact of the parameters and further split the impact of the parameters to obtain a band wise distribution, wherein the band wise distribution comprises of one or more numerical ranges depicting a probabilistic effect of the impact towards the performance of one or more target object. The method further comprises of generating a probabilistic effect of impact of parameter over the proportionality relation so determined to further provide predictive analysis. The method further comprises of generating a standard form of the band wise distribution so obtained and to provide a recommending action with respect to the probabilistic effect so depicted.

It is to be understood that both the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 illustrates system architecture to provide a predictive analysis in accordance with some embodiments.

FIG. 2 illustrates a flow chart towards the performance of system to provide predictive analysis in accordance some embodiments.

FIG. 3 illustrates a functioning of the system in accordance with some embodiments.

FIG. 4 illustrates an overall functioning of some embodiments.

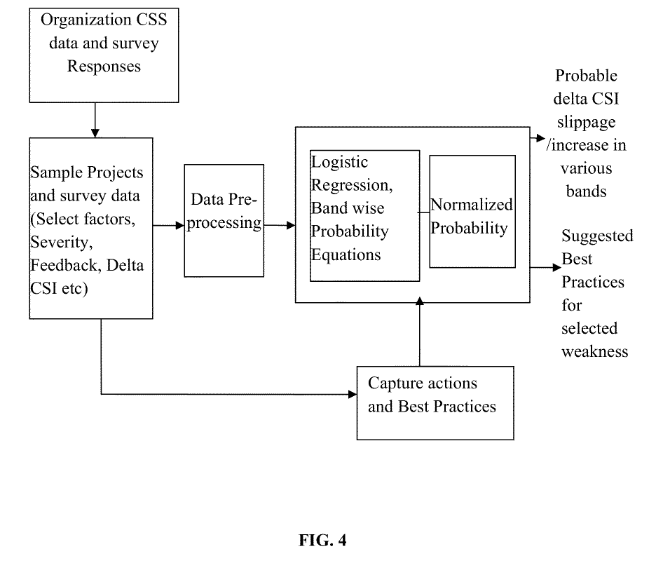

FIG. 5 is a block diagram of an exemplary computer system for implementing embodiments consistent with the present disclosure.

### DETAILED DESCRIPTION

Exemplary embodiments are described with reference to the accompanying drawings. The words “comprising”, “having”, “containing”, and “including”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an”, and “the” include plural references unless the context clearly dictates otherwise. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

One or more components may be described as modules. For example, a module may include self-contained component in a hardware circuit comprising of logical gate, semiconductor device, integrated circuits or any other discrete component. The module may also be a part of any software program executed by any hardware entity for example processor. The implementation of module as a software program may include a set of logical instructions to be executed by the processor or any other hardware entity. Further a module may be incorporated with the set of instructions or a program via an interface.

The present disclosure relates to a computer implemented system and method to provide predictive analysis towards performance of target objects associated with an organization with respect to one or more parameters affecting the performance. More particularly, various embodiments are capable of determining a proportionality relation between the performance of the target object and the parameters affecting the performance to find out the impact of the parameters over the performance. Such embodiments can generate a probabilistic effect of the impact over the proportionality relation so determined to further provide predictive analysis. Further, the embodiments can provide a standard form of band wise distribution of impact of parameters used to generate a probabilistic effect of the impact over the performance of target object.

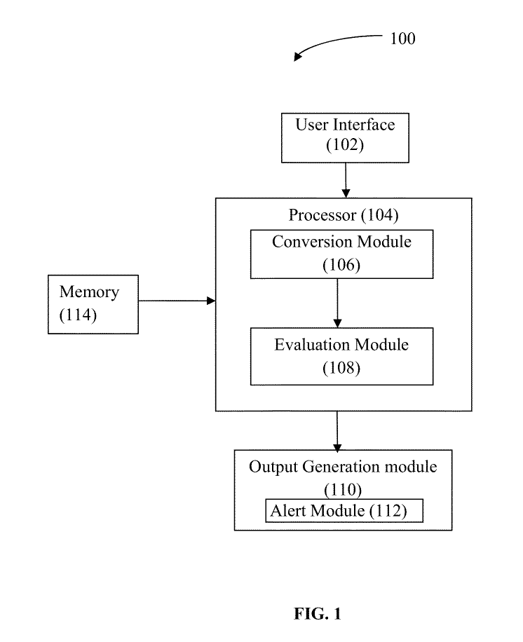

In accordance with an embodiment, referring to FIG. 1, the system (100) may comprise a user interface (102) configured to receive parameters to be fed as an input along with an intensity level. The system (100) may further comprise a processor (104) coupled to a memory (114). The processor (104) may be configured to determine a proportionality relation by using a logical regression technique, between the performance of the target object and the parameter so selected via user interface. The processor (104) may further comprise a conversion module (106) configured to select a threshold value from a pre-defined truth table to convert the parameters selected by the user into a group level model factors with the associated intensity level. The processor (104) may further comprise an evaluation module (108) configured to determine an impact of the parameter fed as the input and further split the impact in a band wise distribution. The system (100) may further comprise an output generation module (110) configured to generate a probabilistic effect of the impact of parameters over the proportionality relation so determined. The probabilistic effect provides predictive analysis towards performance of the target objects associated with the organization.

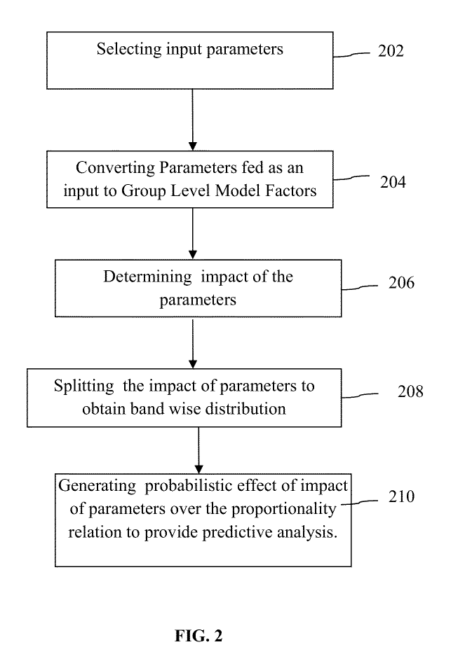

The user interface (102) may be configured to allow the user to select the parameters to be fed as the input along with an intensity level (as shown in step 202 of FIG. 2). The parameters may further comprise a projects related data, customer satisfaction index information and corresponding customer survey response information. The project related data may further comprise project events, and project scenarios, project issues or weaknesses, along with severity (intensity level). The parameters providing a negative effect may comprise project related issues, events or weakness and the input parameters providing a positive effect may comprise project related best practices, actions or improvements. The user interface (102) receives the parameter that comprises previous probabilistic effect so generated for performing a next predictive analysis. The previous probabilistic effect generated comprises previously calculated Customer Satisfaction Index data for the projects selected so far.

In accordance with another embodiment, the parameters fed as the input comprises organization customer satisfaction survey data extracted for a defined time period. For example, the data may be extracted on a half yearly basis. The projects data may be collected for which customer satisfaction index data has been collected. The project related data further includes project management, governance, competence, cost, quality, schedule, and responsiveness, and resource management, problem solving attitude, value addition and political aspect. Identification of factors related to project weakness or issues etc) could be triggered from various sources that includes health check, RAG (Red Amber & Green) assessment, management review, focus or risk review, audits, customer escalations, verbal dissatisfaction and missed commitments. Population of the project data may be further segmented into three sub populations as projects for which satisfaction index may be dropped or decreased, projects for which satisfaction index may be increased or improved and projects for which satisfaction index remained same. For example, list of 42 factors was finalized from organization experience that primarily influence (negatively or positively) client perception that may be reflected in customer satisfaction index. The factors represent various scenarios, events, situations at project level during typical software development and service life cycle.

According to another embodiment, a survey enabled in a knowledge management system, can be used to capture relevant factors and level of severity from the project data. Survey data captured along with qualitative feedback to have input factors that results in respective projects client satisfaction index slippage or increase.

The input parameters are selected along with an intensity level wherein the intensity level may further comprise intensity of the impact that can influence the target object. For example, the intensity level considered here may be low, medium, high and very high. The intensity level may be further dependent or may be set according various combinations built from the input parameters to further form group models.

In accordance with another embodiment, the input parameters are pre-processed before the user's selection through the user interface with respect to their affect on the performance. The input parameters are pre-processed by way of operations, the operations may further comprise data formatting, data cleansing, rationalization, transformation, factor grouping and model fitment. The pre-processing may be a single occurring instance before performing predictive analysis of the performance of target objects. The pre-processing helps in filtering or sorting the total parameters to further retain pertinent parameters which are later selected and fed as the input to the system (100). The pre-processing includes executing a 1st pass to identify groups of the input parameters or factors that have significant impact on the performance of target object. To execute 2nd pass of logistic regression to derive model variables (Constants, Coefficients etc) and formulate logit equation which may be further used to calculate the impact of parameters or factors on the performance of target object depicting probabilistic effect in terms of band wise distribution.

In accordance with another embodiment, the system (100) may further comprise the processor (104) coupled to the memory (114), the processor (104) may be configured to determine proportionality relation by using a logical regression technique, between the performance of the target object and the input parameter so selected. The performance of target object further measured in terms of customer or client satisfaction index. The target object may further comprise prediction in variation of customer satisfaction index.

The processor (104) may further comprise the conversion module (106) configured to select a threshold value from a pre-defined truth table to convert the input parameters selected by the user into a group level model factors with the associated intensity level (as shown in step 204 of FIG. 2). The conversion of the input parameters may be to provide flexibility to the user and to cater to variation in user selection of factors within a logical group. For example, intensity factor of both individual factors and group variables could be at 4 levels (low, medium, high and very high). An inbuilt rule engine (truth table mapping) converts the user selected input factors along with associated intensity into respective group variables' magnitude or severity. The built-in truth table elevates group level severity (factor ordinal levels) used as input to the evaluation module (108). The processor ( )104 by way of further modules performs all the calculations by using various techniques/set of embedded instructions.

In accordance with another embodiment, the factors are grouped based on logical relationship and mutual exclusivity. The 42 factors are grouped and transformed into 11 logical groups. The pre-processing includes preliminary data filtering (of survey feedback) and converting initial 42 factors into set of logical group variables based on mutual exclusivity, coherence and logical relationships. For example, Domain Competence, Technical Competence and Project Management Competence are three distinct factors. Survey feedback indicates that either one (mutually exclusive) of these three factors are selected which are logically grouped (as competence) into single Group Variable. Similarly, the 42 factors were transformed into logically bound 11 group variables (factors), by assigning a suitably elevated intensity, to provide multiple selections within a group variable. Effect of the various group variables to influence the outcome was determined statistically by applying logistic regression. Applying logistic regression technique (1^{st} pass) to key input group variables (7 out of 11) that have critical cause and effect relationship in order to influence the outcome may be also identified.

In accordance with another embodiment, the factors fed as input (giving a negative effect) that are converted into groups as presented below:

TABLE 1
Example Group Conversion of Negative-Effect Input Factors

| Factors: Scenario/Event/Issues/Weakness | Group |
|---|---|
| Resource Competence/Exp level gap--->Domain | Grp2 |
| Resource Competence/Exp level gap--->Project/Program Management | Grp2 |
| Resource Competence/Exp level gap--->Technical | Grp2 |
| Configuration Mgmt →Process not followed | Grp3 |
| IT Governance →Code Quality/Stds compliance | Grp3 |
| Non Functional Req → Access Control/Security Issues | Grp3 |
| Non Functional Req → Performance Issues | Grp3 |
| Customer Connect → Lack of Leadership connect | Grp4 |
| Project Mgmt - Governance--->Absence of good Metric reporting/dashboard | Grp5 |
| Project Mgmt - Governance--->Inability to flag risk/issue well in advance | Grp5 |
| Project Mgmt - Governance--->Lack of Customer connect, Transparent sharing, | Grp5 |
| Status review etc | |
| Go-live Performance → Backout/$ Impact/Down Time/High Cust FTE | Grp6 |
| Quality of Deliverables →Go Live-Show-stopper/High Sev Defects | Grp6 |
| Political/Other →Manager is pro-competitor etc | Grp7 |
| Political/Other →Organization Change in Customer Organization | Grp7 |
| Escalation/Complaint Mgmt--->Issues with Responsiveness/RCA/Formal & | Grp8 |
| On Time closure | |
| Escalation/Complaint Mgmt--->Urgency/priority not shown to customer | Grp8 |
| concern/feedback | |
| Customer Priority--->Support documentation, User Training etc not prioritized/ | Grp8 |
| addressed | |
| Collaboration--->Issues with other entities, vendors/3rd parties impacted | Grp8 |
| Customer/User | |
| Preventive VS Reactive--->Lack of focus in CTB (Preventive/Adaptive | Grp8 |
| maintenance, Enhancements etc) | |
| Proactive VS Reactive--->Reactive process/management | Grp8 |
| RCA and Problem Solving--->Root Causal/Problem solving focus missing | Grp8 |
| SIT/UAT - Test Mgmt--->Test Failure/High Defect Rate/Show-stopper/High | Grp9 |
| Sev Defects | |
| SIT/UAT - Test Mgmt--->Defects/Functional Gaps leading to CRs SIT/UAT - | Grp9 |
| Test Mgmt--->High Business/User FTE | Grp9 |
| SIT/UAT - Test Mgmt--->Poor Test/Path/Scenario/Data Coverage Quality of | Grp9 |
| Service/Deliverables--->Service or Delivery Quality issues | Grp9 |
| Resource Mgmt → Attrition of Key/named resources | Grp10 |
| Resource Mgmt--->Resource Availability/On-boarding issue, inability to ramp | Grp10 |
| up | |
| Resource Mgmt → Resource Turnover/Release w/o customer consent | Grp10 |
| Resource Mgmt → Shifting key resources from Onsite | Grp10 |
| Schedule adherence →Delay in Intermediate Deliverables | Grp11 |
| Schedule adherence →Shift/postponement in Release/Go-live Milestone | Grp11 |
| Value Addition → Contractual savings/value add not met | Grp12 |
| Value Addition → No value add apart from BAU | Grp12 |
| Value Addition → Proactive ideas/Out of Box thinking not shared | Grp12 |

In accordance with an exemplary embodiment, the input factors (giving a positive effect) converted into groups is presented below:

TABLE 2
Example Group Conversion of Positive-Effect Input Factors

| Factors: Action/Improvement/Strength/Appreciation | Group |
|---|---|
| Competence (Proj Mgmt)---> Knowledge/Skill | Grp1 |
| Competence (Technology)---> Knowledge/Skill | Grp1 |
| Competence (Domain)---> Knowledge/Skill | Grp1 |
| Project Mgmt/Governance →Proactive sharing of issues, flagging Risks | Grp2 |
| Project Mgmt/Governance →Detailed planning & regular sharing of progress & | Grp2 |
| status | |
| Project Mgmt/Governance →Regular connect at project, account & leadership | Grp2 |
| level | |
| Project Mgmt/Governance →Regular review of Project performance by account | Grp2 |
| leadership | |
| Escalation/Complaint Mgmt→No complaint but appreciations, received | Grp3 |
| Customer priority→Implicit customer priority (documentation, training etc) has | Grp3 |
| been prioritized | |
| Proactive Vs Reactive→Proactive actions, planning, thought process played as key | Grp3 |
| differentiator | |
| Preventive Vs Reactive→ Focus on preventive support helped reducing need for | Grp3 |
| reactive support | |
| RCA and Problem Solving→ Root cause and problem solving focus made | Grp3 |
| substantial difference | |
| Collaboration →With other entities to prioritize meeting project objectives/ | Grp3 |
| performance baselines | |
| Political/Other → Manager is pro-competitor etc | Grp4 |
| Political/Other→ Organization change in customer organization | Grp4 |
| Go-live/Release Performance → Ability to contain High Severity defects/show | Grp5 |
| stoppers/Business impact | |
| SIT/UAT - Test Mgmt→ High pass rate, no major defects/show stoppers& backlog | Grp5 |
| SIT/UAT - Test Mgmt---> Req/Design Gaps not found during SIT/UAT | Grp5 |
| Quality of Deliverables → High quality deliverables maintained all through | Grp5 |
| Quality of Deliverables →Containment of high Severity defects/show shoppers in | Grp5 |
| SIT/UAT | |
| KPI (Metric/SLA) Performance→ Well within customer expectation, showing | Grp5 |
| improvement trend | |
| IT Governance → Compliance to IT framework/governance | Grp6 |
| IT Governance →Meeting code quality expectations | Grp6 |
| Non Functional Requirement → Meeting performance and security expectations | Grp6 |
| Resource Mgmt→ No customer impact (induction, on-boarding, ramp-up, sudden | Grp7 |
| release or attrition) | |
| Value Addition → Sharing ideas/Suggestions/Improvements/thought leadership/ | Grp8 |
| best practices etc | |
| Usage of Delighter→Tool Usage, Reusable components, Best practice adoption etc | Grp8 |
| Schedule adherence → did not include any delay in overall completion and major | Grp9 |
| milestones | |
| Schedule adherence→ critical paths were managed effectively | Grp9 |
| SIT/UAT - Test Mgmt→ Schedule compliance | Grp9 |
| Configuration Mgmt→ No surprise from configuration lapses | Grp10 |
| Change Mgmt→ No Customer impact (Budget overrun and/or CRs due to | Grp10 |
| recruitment gaps) | |

In accordance with another embodiment, built-in truth table and the usage to determine group level severity from selected factors severity/magnitude is presented below:

TABLE 3
Example Truth/Group Level Severity Table

| | Group Severity | Action |
|---|---|---|
| Level 1 - Truth Table | | |
| If none entered | ZERO(0) | EXIT |
| At least 1 Low(1) | Low(1) | |
| At least 1 Med(2) | Med(2) | |
| At least 1 High(3) | High(3) | |
| At least 1 Very High(4) | Very High(4) | EXIT |
| Level 2 - Truth Table | | |
| If all Low(1) | Low(1) | EXIT |
| If <=2 Low(1) & All other Not Entered(0) | Low(1) | EXIT |
| If >2 Low(1) & All other Not Entered(0) | Med(2) | EXIT |
| If 1 Med(1) & All other Low(1) or | Med(2) | EXIT |
| Not Entered(0) | | |
| If 1 High(1) & All other Low(1) or | High(3) | EXIT |
| Not Entered(0) | | |
| If 1 or 2 Med(2) & All other Low(1) or | Med(2) | EXIT |
| not entered(0) | | |
| If 3 Med(2) & All other Low or Not entered | High(3) | EXIT |
| If >3 Med(2) | Very High(4) | EXIT |
| If >=2 High(3) | Very High(4) | EXIT |
| If 1 High(3) and >=2 Med(2) | Very High(4) | EXIT |
| If 1 High(3) and >=3 Low(1) | Very High(4) | EXIT |
| If 1 High(3) and 1 Med(2) and 2 Low(1) | Very High(4) | EXIT |

Referring to FIG. 1, the system (100) may further comprise the evaluation module (108) configured to determine an impact of parameters in terms of the band wise distribution (as shown in step 206 and 208 of FIG. 2). Further the band wise distribution comprises one or more numerical ranges depicting probabilistic effect of the impact of parameters towards the performance of one or more target object. The ranges of the band wise distribution of probability of the parameter may be 0-2%, 2-5%, 5-10%, 10-15%, 15-20% and %20+.

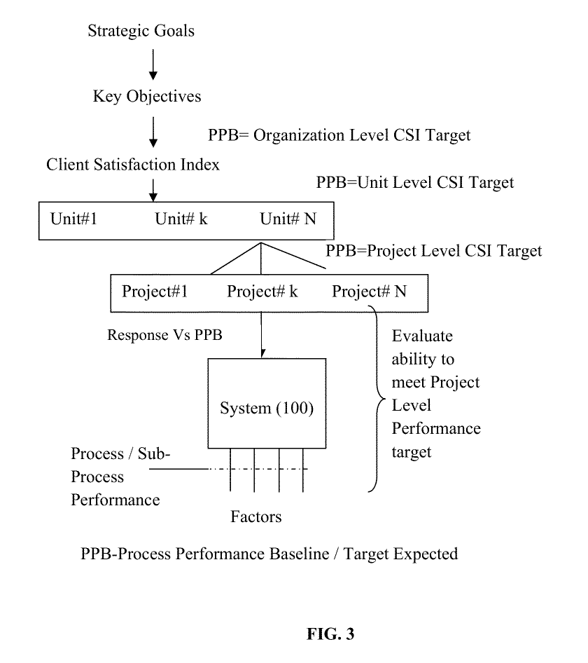

Referring to FIG. 3, a target may be set for Client Satisfaction Index at organization level based on history information, experiences and leadership mandate, often termed as expected Process Performance Baseline (PPB). The underlined process may be Organization Performance Management Process which may be linked to other sub-processes. While setting up the target, the evaluation of current process performance may be performed to assess current capability. The evaluation may be further linked to various units' performance objectives, captured at individual client touch-point (executing projects). In general, Client Satisfaction may be captured by conducting surveys, measuring the survey, analyzing and formulating action plan aimed at future improvement.

Referring to FIG. 3, by way of a specific example, the system (100) may work as a process performance model to perform organization's performance management by capturing key objectives (input parameters/Factors) and determining Client Satisfaction Index. There may be plurality of units and projects associated with them. The processor (104) processed the input parameters/Factors to evaluate parameter and to provide predictive analysis. For example, the processor (104) evaluates ability to meet Project Level Performance target (PPB (as shown in FIG. 3). Process Performance Baseline (PPB) may be process performance target in terms of Customer/Client Satisfaction Index.

According to another embodiment, the satisfaction index captured from survey and the calculated impact on the satisfaction index providing delta satisfaction index may be a continuous data. So it has been considered as various bands (0-2%, 2-5%, 5-10%, 10-15%, 15-20% and %20+) to convert the outcome data that may be the parameter probability data (probabilistic effect of the impact of parameters over the proportionality relation) as discrete (as shown in step 210 of FIG. 2).

The evaluation module (108) may be further configured to apply logistic regression technique to establish a cause and effect relationship (by way of proportionality relation) between group level model factors with associated intensity level and its effect on one or more target object. The evaluation module (108) further identifies key influence factors (p value), relative importance/Weightage (odds ratio) of various factors, probability distribution in various bands and model accuracy/fitment (concordance) by using the group level model factors with associated intensity level obtained from the conversion module (106). Further, logistic regression technique (2^{nd} Pass) may be executed to derive model variables (Constants, Coefficients etc) and formulate Logit equation to further calculate the band wise distribution of impact of parameter and to further generate a probabilistic effect of the of parameters over the proportionality relation so determined in order to provide the predictive analysis.

The calculative part that may be so performed by the processor (104) and later the output generation module (110) is presented below:

Logit(P)=Gj=B0+B1*X1+B2*X2+ . . . +Bk*Xk

P=Probability(instance j)=1/(1+Exp[−Gj])

Still referring to system (100) and the evaluation module (108), the proportionality relation between the performance of the target object and the input parameters further provides decrease in the performance of one or more target object or an increase in the performance of the target object with respect to the input parameters. The evaluation module (108) determines the proportionality relation to further provide at least a delta positive increase or a delta negative slippage in previously obtained customer satisfaction index as input parameter.

Herein, the parameters when fed as the input provides a negative effect may comprise project related scenarios, issues, events or weakness that has visibility to client and the input parameters providing a positive effect may comprise project related best practices, actions or improvements visible to client.

According to yet another embodiment, the system (100) may be configured to establish a proportionality relationship to predict possible slippage (delta decrease) in client satisfaction index (CSI) for a set of applicable factors and level of influence. Delta CSI slippage calculated for each project instance. In order to provide better predictability to user based on range of slippage, 6 possible bands chosen. Accordingly, delta CSI slippage data converted into six possible bands (0-2%, 2-5%, 5-10%, 10-15%, 15-20% and >20%). Fitment in a band containing a higher slippage probability, greater may be the risk, which in turn warrants management attention and rigor in action planning and monitoring. Similarly, the system (100) may be also configured to establish a relationship to predict possible rise (delta increase) in client satisfaction index (CSI) for a set of applicable factors and level of influence. The objective of predicting delta increase in CSI for a set of applicable factors and level of influence may be to evaluate ability of planned/implemented actions to elevate CSI level in meeting desired target.

Still referring to FIG. 1, the system (100) comprises the output generation module (110) configured to generate probabilistic effect of the impact of parameter over the proportionality relation so determined to further provide the predictive analysis (as shown in step 210 in FIG. 2). The output generation module (110) may be further configured to generate standard form of the band wise distribution so obtained from the evaluation module (108). The output generation module (110) thus configured has built-in ability to rationalize the band wise distribution obtained from evaluation module based on previous customer satisfaction index data. The standard form of the band wise distribution may be generated by applying a technique of normalization.

According to another embodiment, the output generation module (110) has built-in ability to rationalize the band wise probability distribution based on previous customer satisfaction index data. The rationalization may be performed to transform the model output into more realistic bands when organization previous experience data is applied. The output generation module (110) normalizes the probability distribution based on current satisfaction index bands (For example as 90-100%, 80-90%, 70-80%, 60-70%, <60% etc). The normalization may be performed in order to rationalize the model further based on a project's current satisfaction level. It has been observed this plays an important role in determining the delta negative or positive i.e. client satisfaction decrement or improvements, when similar input factors is chosen. This may be calculated by using a formula:

Normalized(independent)Probability(band 1)=Probability(band 1|organization experience)*Probability(band 1|selected model factors)

Still, in accordance with another embodiment, the output generation module (110) may be further configured to provide one or more recommending action with respect to the probabilistic effect so depicted. The output generation module (110) may further comprise an alert module (112) configured to provide recommendations with respect to delta negative slippage so determined. The output generation module (110) may be configured with an action knowledge base that comprises organization best practices to improve the factors modeled in the system. Best practices or actions based on previous data will be suggested for corresponding delta negative slippage. When the user selects a combination of input factors, corresponding best practices (suggested improvement actions) would be guided.

Yet, according to another exemplary embodiment, the system (100) uses present scenarios of a project and predicts probability of possible (delta) slippage in various bands. This helps projects to link project events/scenarios to probable impact (−ve) on future client satisfaction index, by observing the probability distribution in various bands and use it as lead indicators to act proactively and take informed decision towards reversing or minimizing the impact. The model also normalizes the probability distribution based on current client satisfaction index band (90-100%, 80-90%, 70-80%, 60-70%, <60% etc). The model also suggests a set of best practices/actions, based on selected weakness (model input factors) that was captured through a similar survey among projects, for which there was % increase in client satisfaction index.

The system and method illustrated provides predictive analysis towards performance of one or more target object associated with an organization with respect to one or more parameters affecting the performance, the system and method may be illustrated by a working example stated in the following paragraph; the process is not restricted to the example only:

In accordance with another embodiment, the system (100) may be used to provide predictive analysis towards increase or decrease in customer satisfaction index (which may be the target object here). The system (100) may be configured in manner to work as negative model (−ve) when there is decrease in Client Satisfaction Index and positive model (+ve) when there is increase in Client Satisfaction Index based on the input parameters. The system (100) may be also used in variety of scenarios as explained below.
Case 1: Any project, at any point of time, having specific issue(s) or weakness(s) (as input parameters and relevant intensity level selected by the user)
i) Use −ve Model to assess possible impact on CSI (delta % decrease in future CSI)
Case 2: Any project, having specific issue(s) or weakness(s) and some strength or improvements (as input parameters and relevant intensity level selected by the user)
ii) Use both −ve Model and +ve Model to assess possible impact on CSI, but addition of probabilities may be not recommended
Case 3: Projects fail to attain desired CSI (Target/Specification Limit) or if CSI is dropped or having dissatisfaction (Attribute or as mentioned in Top 3 OFI—Opportunity for Improvement section); must have action plan ready and available
iii) Use −ve Model
a) To validate, if planned action(s) are in line with suggested action(s)/Best Practices
iv) Use +ve Model
a) To validate how much % CSI elevation would be possible by implementing these action(s) and if that may be sufficient to meet the Target
b) Ongoing basis, to evaluate effectiveness of these implemented actions and probable +ve influence on CSI
Case 4: Projects with High CSI and only Strengths (no issue, no weakness)
v) To raise the bar and use +ve Model based on further improvement areas selected and acted upon

Sample illustration of CSS Negative Model to demonstrate how input factor selection may be translated into model output as probability distribution in 6 bands is provided below:

TABLE 4
Example Factor Selection - Model Output Mapping

| | | | | Elevated Group | |
|---|---|---|---|---|---|
| | | | | Variable | |
| | | | | after truth | |
| Factor selection by User | Intensity | Value | Group | table applied | |
| Resource Competence/Exp level gap | High | 3 | Grp2 | High | 3 |
| → Project/Program | | | | | |
| Management | | | | | |
| Project Mgmt - Governance → | Medium | 2 | Grp5 | Medium | 2 |
| Inability to flag risk/issue | | | | | |
| in advance | | | | | |
| SIT/UAT - Test Mgmt--->Test | High | 3 | Grp9 | Very High | 4 |
| Failure/High Defect Rate/Show- | | | | | |
| stopper/High Severity Defects | | | | | |
| SIT/UAT - Test Mgmt → High | Medium | 2 | | | |
| Business/User FTE | | | | | |
| SIT/UAT - Test Mgmt →Poor | Medium | 2 | | | |
| Test/Path/Scenario/Data Coverage | | | | | |

Note:
No factors selected in Other Groups Grp7, Grp8, Grp10 and Grp12.

TABLE 5
User Selection of Model Factors

| Grp2 | Grp5 | Grp7 | Grp8 | Grp9 | Grp10 | Grp12 |
|---|---|---|---|---|---|---|
| 3 | 2 | 0 | 0 | 4 | 0 | 0 |

TABLE 6
Example Logistic Regression Model Equations for CSS -ve Model

| Coeff | Coeff | Coeff | Coeff | Coeff | Coeff | Coeff |
|---|---|---|---|---|---|---|
| (Grp2) | (Grp5) | (Grp7) | (Grp8) | (Grp9) | (Grp10) | (Grp12) |
| −0.4910 | −0.3464 | −0.5766 | −0.3183 | −0.5092 | −0.4093 | −0.2192 |
| Const1 | Const2 | Const3 | Const4 | Const5 | | |
| −0.8071 | 0.7106 | 2.1771 | 3.0233 | 4.0331 | | |

Logit(P)=G1=G(Band1)=Const1+[Grp2*Coeff(Grp2)+Grp5*Coeff(Grp5)+Grp7*Coeff(Grp7)+Grp8*Coeff(Grp8)+Grp9*Coeff(Grp9)+Grp10*Coeff(Grp10)+Grp12*Coeff(Grp12)]=−5.0097

P=Probability(Band1)=1/(1+Exp[−G(Band1)])=0.006628725

P1=Probability(Band1)=0.006628725

Logit(P)=G1=G(Band2)=Const2+[Grp2*Coeff(Grp2)+Grp5*Coeff(Grp5)+Grp7*Coeff(Grp7)+Grp8*Coeff(Grp8)+Grp9*Coeff(Grp9)+Grp10*Coeff(Grp10)+Grp12*Coeff(Grp12)]=−3.4920

P=Probability(Band1&2)=1/(1+Exp[−G(Band2)])=0.029541173

P2=Probability(Band2)=0.029541173−0.006628725=0.022912448

Logit(P)=G1=G(Band3)=Const3+[Grp2*Coeff(Grp2)+Grp5*Coeff(Grp5)+Grp7*Coeff(Grp7)+Grp8*Coeff(Grp8)+Grp9*Coeff(Grp9)+Grp10*Coeff(Grp10)+Grp12*Coeff(Grp12)]=−2.0256

P=Probability(Band1,2&3)=1/(1+Exp[−G(Band3)])=0.116546327

P3=Probability(Band3)=0.116546327−0.029541173=0.087005155

Logit(P)=G1=G(Band4)=Const4+[Grp2*Coeff(Grp2)+Grp5*Coeff(Grp5)+Grp7*Coeff(Grp7)+Grp8*Coeff(Grp8)+Grp9*Coeff(Grp9)+Grp10*Coeff(Grp10)+Grp12*Coeff(Grp12)]=−1.1793

P=Probability(Band1,2,3&4)=1/(1+Exp[−G(Band4)])=0.235174484

P4=Probability(Band4)=0.235174484−0.116546327=0.118628157

Logit(P)=G1=G(Band5)=Const5+[Grp2*Coeff(Grp2)+Grp5*Coeff(Grp5)+Grp7*Coeff(Grp7)+Grp8*Coeff(Grp8)+Grp9*Coeff(Grp9)+Grp10*Coeff(Grp10)+Grp12*Coeff(Grp12)]=−0.1695

P=Probability(Band1,2,3,4&5)=1/(1+Exp[−G(Band5)])=0.457726163

P5=Probability(Band5)=0.457726163−0.235174484=0.222551679

P6=Probability(Band6)=1−(P1+P2+P3+P4+P5)=1−0.457726163=0.542273837

Below are listed the output results (i.e. standardized probabilistic effect in terms of numerical values for both 2 the models:
Case 1: Band wise probability distribution when last received customer satisfaction level (CSI) may be 80-90%

TABLE 7
Example Population Band Dist. %

| CSI- % | | Core model | CSI | Conditional | | Model |
|---|---|---|---|---|---|---|
| slippage Band | | Probability | <80-90%> | Probability | Normalized | Output |
| 1 | 0-2% | 0.006628725 | 0.251552795 | 0.001667474 | 0.015845874 | 1.58% |
| 2 | 2-5% | 0.022912448 | 0.251552795 | 0.00576369 | 0.054771883 | 5.48% |
| 3 | 5-10% | 0.087005155 | 0.223602484 | 0.019454569 | 0.184875195 | 18.49% |
| 4 | 10-15% | 0.118628157 | 0.118012422 | 0.013999596 | 0.133037031 | 13.30% |
| 5 | 15-20% | 0.222551679 | 0.62111801 | 0.013823086 | 0.131359666 | 13.14% |
| 6 | 20+% | 0.542273837 | 0.093167702 | 0.050522407 | 0.480110352 | 48.01% |

Case 2: Band wise probability distribution when last received customer satisfaction level (CSI) may be 60-70%.

TABLE 8
Example Population Band Dist. %

| CSI- % | | Core model | CSI | Conditional | | Model |
|---|---|---|---|---|---|---|
| slippage Band | | Probability | <60-70%> | Probability | Normalized | Output |
| 1 | 0-2% | 0.006628725 | 0.105263158 | 0.000697761 | 0.006898963 | 0.69% |
| 2 | 2-5% | 0.022912448 | 0.210526316 | 0.004823673 | 0.04769307 | 4.77% |
| 3 | 5-10% | 0.087005155 | 0.421652632 | 0.036633749 | 0.362208608 | 36.22% |
| 4 | 10-15% | 0.118628157 | 0.157894737 | 0.018730762 | 0.185196525 | 18.52% |
| 5 | 15-20% | 0.222551679 | 0.052631579 | 0.011713246 | 0.115812296 | 11.58% |
| 6 | 20+% | 0.542273837 | 0.052631579 | 0.028540728 | 0.282190539 | 28.22% |

As shown in above table 7 and 8, the effect of output generation module (110) may be presented. In accordance with another exemplary embodiment, the system (100) may be a core model. The system (100) or Core model calculated probability may be further normalized (conditional probability) with overall distribution probability to predict band wise probability distribution for selected factors. The system (100) outputs maximum probability in band 6 (54.22%) and it cannot further optimize this based on previously obtained CSI Band. Hence, for both CSI bands (80-90% and 60-70%) the core model output remains the same. But when effect of output generation module (110) applied the most probable band changes; for CSI band 80-90%, it may be Band 6 with probability 48.01% (normalized), while for CSI band 60-70% it now would show Band 3 with probability 36.22% (normalized).

### Computer System

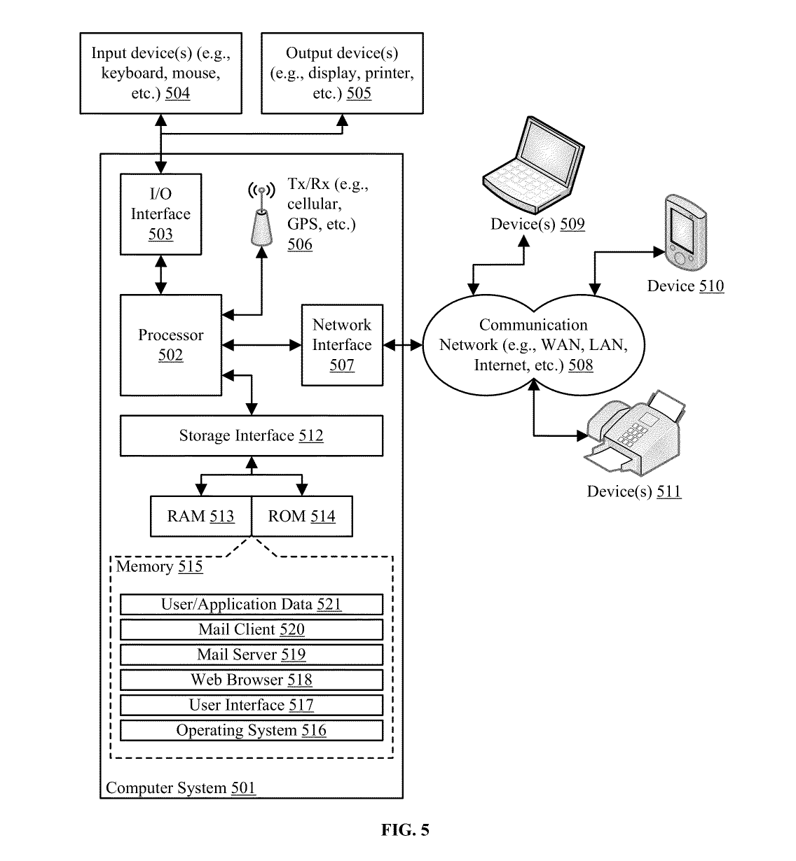

FIG. 5 is a block diagram of an exemplary computer system for implementing embodiments consistent with the present disclosure. Variations of computer system 501 may be used for implementing the devices and algorithms disclosed herein. Computer system 501 may comprise a central processing unit (“CPU” or “processor”) 502. Processor 502 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the modules, data, variables, records, etc. as described in this disclosure. For example, the modules described in this disclosure may be implemented in software, and processor 502 may be configured to execute the modules stored as part of the user/application data 521. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described a system and method facilitating communication in an adaptive virtual environment. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A performance predictive analysis system, comprising:
a processor; and
a memory disposed in communication with the processor, and storing processor-executable instructions comprising instructions to:
receive one or more parameters and an associated intensity level to predict performance of a target object associated with an organization;
determine a proportionality relation between the performance of the target object and the one or more parameters, by applying a logical regression technique over the one or more parameters;
select a threshold value from a pre-defined truth table to convert the one or more parameters into one or more group-level model factors with the associated intensity level;
determine an impact of the one or more parameters on the performance in terms of a band wise distribution; and
identify a probabilistic effect, based on the determined impact, of the proportionality relation between the performance of the target object and the one or more parameters.

2. The system of claim 1, wherein the performance of the target object is measured as a variation in customer satisfaction index.

3. The system of claim 1, wherein the one or more parameters comprise projects related data, prior customer satisfaction index information, and corresponding survey response information, project events and project scenario.

4. The system of claim 1, wherein the one or more parameters comprise a previously identified probabilistic effect.

5. The system of claim 1, wherein the band wise distribution comprises numerical ranges of 0-2%, 2-5%, 5-10%, 10-15%, 15-20% and %20+.

6. The system of claim 1, wherein the proportionality relation is at least one of: a delta positive increase, or a delta negative slippage in a customer satisfaction index.

7. The system of claim 6, the instructions further comprising instructions to:
provide one or more recommendations with respect to the delta negative slippage in the customer satisfaction index.

8. The system of claim 1, wherein the input parameters received are each categorized as either parameters inducing a negative effect, or parameters causing a positive effect.

9. The system of claim 1, the instructions further comprising instructions to:
generate a standard form of the probabilistic effect by applying a technique of normalization over the band wise distribution; the standard form being generated by using a previous customer satisfaction index data.

10. A performance predictive analysis method, comprising:
receiving one or more parameters and an associated intensity level to predict performance of a target object associated with an organization;
determining a proportionality relation between the performance of the target object and the one or more parameters, by applying a logical regression technique over the one or more parameters;
selecting a threshold value from a pre-defined truth table to convert the one or more parameters into one or more group-level model factors with the associated intensity level;
determining an impact of the one or more parameters on the performance in terms of a band wise distribution; and
identifying a probabilistic effect, based on the determined impact, of the proportionality relation between the performance of the target object and the one or more parameters.

11. The method of claim 10, wherein the performance of the target object is measured as a variation in customer satisfaction index.

12. The method of claim 10, wherein the one or more parameters comprise projects related data, prior customer satisfaction index information, and corresponding survey response information, project events and project scenario.

13. The method of claim 10, wherein the one or more parameters comprise a previously identified probabilistic effect.

14. The method of claim 10, wherein the band wise distribution comprises numerical ranges of 0-2%, 2-5%, 5-10%, 10-15%, 15-20% and %20+.

15. The method of claim 10, wherein the proportionality relation is at least one of:
a delta positive increase, or a delta negative slippage in a customer satisfaction index.

16. The method of claim 10, wherein:
the input parameters received are each categorized as either parameters inducing a negative effect, or parameters causing a positive effect; and
the parameters providing a negative effect comprise project related issues, events, or weaknesses, and the parameters providing a positive effect comprise project related best practices, actions, or improvements.

17. The method of claim 10, further comprising:
generating a standard form of the probabilistic effect by applying a technique of normalization over the band wise distribution; the standard form being generated by using a customer satisfaction index data.

18. The method of claim 15, further comprising:
providing one or more recommendations with respect to the delta negative slippage in the customer satisfaction index.

19. A non-transitory computer-readable medium storing computer-executable performance predictive analysis instructions comprising instructions to:
receive one or more parameters and an associated intensity level to predict performance of a target object associated with an organization;
determine a proportionality relation between the performance of the target object and the one or more parameters, by applying a logical regression technique over the one or more parameters;
select a threshold value from a pre-defined truth table to convert the one or more parameters into one or more group-level model factors with the associated intensity level;
determine an impact of the one or more parameters on the performance in terms of a band wise distribution; and
identify a probabilistic effect, based on the determined impact, of the proportionality relation between the performance of the target object and the one or more parameters.
